(19) United States
(12) Patent Application Publication
(10) Pub. No.: US 2017/0166128 A1
(43) Pub. Date: Jun. 15, 2017

(54) METHOD AND APPARATUS OF HOLOGRAPHIC DRIVE RECORDING

(71) Applicants: Le Holdings (Beijing) Co., Ltd., Beijing (CN); LeCloud Computing Co., Ltd., Beijing (CN)

(72) Inventor: Yong MA, Beijing (CN)

(21) Appl. No.: 15/245,094

(22) Filed: Aug. 23, 2016

Related U.S. Application Data
(63) Continuation of application No. PCT/CN2016/089310, filed on Jul. 8, 2016.

(30) Foreign Application Priority Data
Dec. 14, 2015 (CN) 201510924643.X

(51) Int. Cl. B60R 1/00; B60R 11/04; G03H 1/00; G03H 1/26; H04N 7/18

(52) U.S. Cl. CPC B60R 1/00; G03H 1/268; H04N 7/181; G03H 1/0005; B60R 11/04; B60R 2011/004

(57) ABSTRACT

A holographic drive recording apparatus, is used to record images during a driving process of a vehicle, the apparatus includes: cameras, a processor connected to cameras, and a memory connected to the processor. The cameras are configured to simultaneously capture images in different directions of the vehicle, the memory is configured to separately store the images, and the processor is configured to retrieve the images and synthesize the images into a holographic three-dimensional image with the vehicle as a center when a user needs to watch an image.

### CROSS REFERENCE TO RELATED APPLICATIONS

This application is a continuation application of International patent application No. PCT/CN2016/089310, filed on Jul. 8, 2016, which claims priority to Chinese Patent Application No. 201510924643.X, filed with the Chinese Patent Office on Dec. 14, 2015, both of which are herein incorporated by reference in its entirety.

### TECHNICAL FIELD

The present disclosure relates to the field of drive recording, and in particular, to a method and apparatus of holographic drive recording

### BACKGROUND

At present, driving safety is highly emphasized, and a drive recorder, a rear view camera, and the like have become necessary devices for a driver. However, in most cases, these devices are only capable of displaying captured images in real time, and camera recordings cannot be retrieved again afterwards.

### SUMMARY

According to an aspect, an embodiment of the present disclosure provides a holographic drive recording apparatus, which is used to record images during a driving process of a vehicle. The apparatus includes: a plurality of cameras, a processor connected to the plurality of cameras, and a memory connected to the processor, wherein:

the plurality of cameras is configured to simultaneously capture images in different directions of the vehicle;

the memory is configured to store the plurality of images; and

the processor is configured to: retrieve the plurality of images and synthesize the plurality of images into a holographic three-dimensional image with the vehicle as a center when a user needs to watch an image.

According to another aspect, another of embodiment the present disclosure provides a holographic drive recording method, applied to a driving process of a vehicle that include a plurality of cameras, a processor connected to the plurality of cameras, and a memory connected to the processor. The method includes:

simultaneously capturing images in different directions of the vehicle by the plurality of cameras;

storing, by the memory, the plurality of images; and

retrieving the plurality of images stored in the memory and synthesizing the plurality of images into a holographic three-dimensional image with the vehicle as a center by the processor when a user needs to watch an image.

### BRIEF DESCRIPTION OF FIGURES

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of hardware architecture of an exemplary embodiment of a holographic drive recording apparatus provided in the present disclosure;

FIG. 2 is a flowchart of an exemplary embodiment of a holographic drive recording method provided in the present disclosure; and

FIG. 3 is a schematic diagram of an exemplary embodiment of camera shooting ranges and overlapping areas provided in the present disclosure.

### DETAILED DESCRIPTION

To make the objectives, technical solutions, and advantages of the present disclosure more clear, the present disclosure is further described in detail below with reference to the accompanying drawings and embodiments. It should be noted that, the specific embodiments described herein are merely used to illustrate the present disclosure, but are not used to limit the present disclosure.

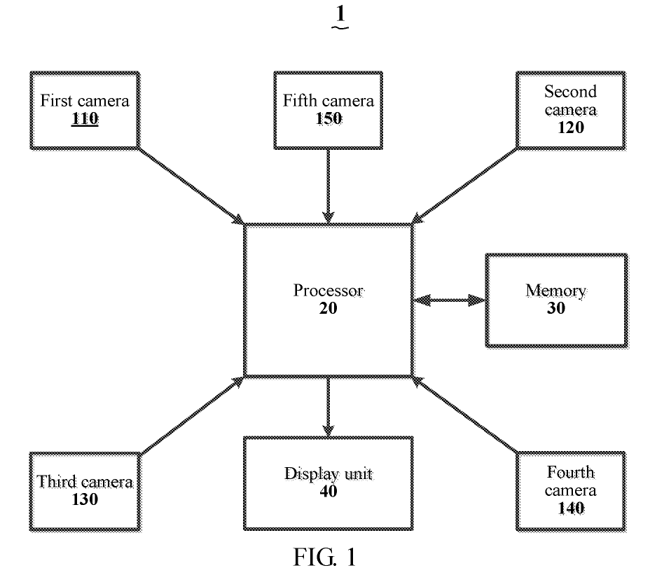

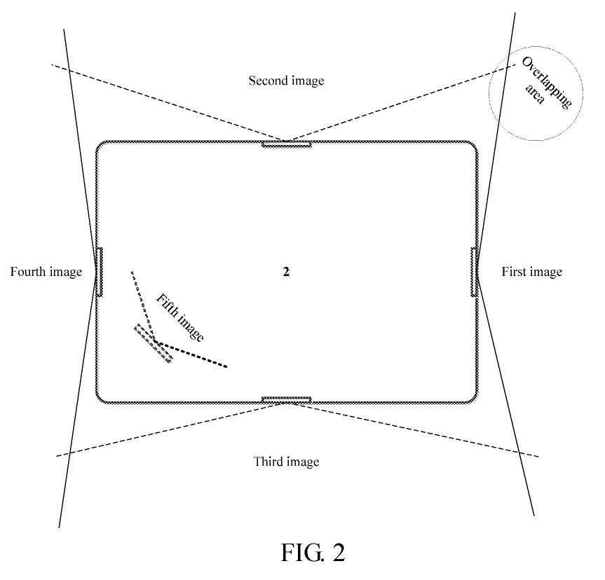

Referring to FIG. 1 and FIG. 2, which are schematic diagrams of hardware architecture of an exemplary embodiment of a holographic drive recording apparatus provided in the present disclosure.

In this embodiment, the holographic drive recording apparatus 1 is installed in a vehicle 2. In some embodiments, the vehicle 2 may be a large automobile, a small automobile, or the like. In some other embodiments, the vehicle 2 may be a special purpose vehicle, for example, a sweeper truck, a mail truck, or the like. The vehicle 2 may further be an emergency vehicle that has a special purpose.

The holographic drive recording apparatus 1 includes but is not limited to: a plurality of cameras, a processor 20, and a display unit 40, where the processor 20 is connected to the plurality of cameras, a memory 30 and the display unit 40.

To acquire images from all directions during a driving process of the vehicle 2, in some embodiments, the plurality of cameras at least includes at least a first camera 110, a second camera 120, a third camera 130, a fourth camera 140, and a fifth camera 150, as shown in FIG. 1. The first to fourth cameras are installed in a front of, on a left of, on a right of, and in a rear of the vehicle 2 respectively, and the fifth camera 150 is installed near a wheel of the vehicle 2. In this embodiment, the fifth camera 150 is installed near a right rear wheel of the vehicle 2. In some other embodiments, the plurality of cameras may further include a camera installed near each wheel of the vehicle 2.

The plurality of cameras is configured to capture images at multiple angles and from multiple directions during the driving process of the vehicle 2 and transmit the captured images to the processor 20. In this embodiment, the plurality of cameras may be wide angle cameras, and a shooting angle of each camera is at least 130°. In this way, images of an external environment can be captured in 360° during the driving process of the vehicle 2, and the fifth camera 150 installed near the wheel of the vehicle 2 can further capture road surface images during the driving process of the vehicle 2. Images captured by the plurality of cameras are shown in FIG. 2, where a first image is an image in front of the vehicle 2 captured by the first camera 110, a second image is an image in the left of the vehicle 2 captured by the second camera 120, a third image is an image in the right of the vehicle 2 captured by the third camera 130, a fourth image is an image in rear of the vehicle 2 captured by the fourth camera 140, and a fifth image is an image under the vehicle 2 captured by the fifth camera 150. Because the wide angle cameras are used, overlapping areas exist between the first image, the second image, the third image, and the fourth image, which implements capture without any dead angle during the driving process of the vehicle 2.

The memory 30 may be a memory of the holographic drive recording apparatus 1, or may be an external storage device such as a Secure Digital Card (SD card) or a Smart Media Card (SM card). The memory 30 may also comprise both the memory of the holographic drive recording apparatus 1 and the external storage device. The memory 30 is configured to store various types of data in the holographic drive recording apparatus 1. In this embodiment, the memory 30 is further configured to separately store the images that are captured by the plurality of cameras during the driving process of the vehicle 2.

The processor 20 is configured to receive the images captured by the plurality of cameras, and analyze and process the images. In this embodiment, the processor 20 may be a digital signal processor.

The display unit 40 is configured to display an image that has been processed by the processor 20.

It should be noted that above-mentioned operation performed is achieved by executing instructions by the processor 20, the instructions are stored in the memory 30. The processor 20 performs the above-mentioned operation by executing the instructions stored in the memory 30.

A non-transitory computed readable storage medium is disclosed in some embodiment, The non-transitory computed readable storage medium storing executable instructions, wherein when the executable instructions are executed by at least one processor causes the at least one processor to execute aforesaid method of holographic drive recording.

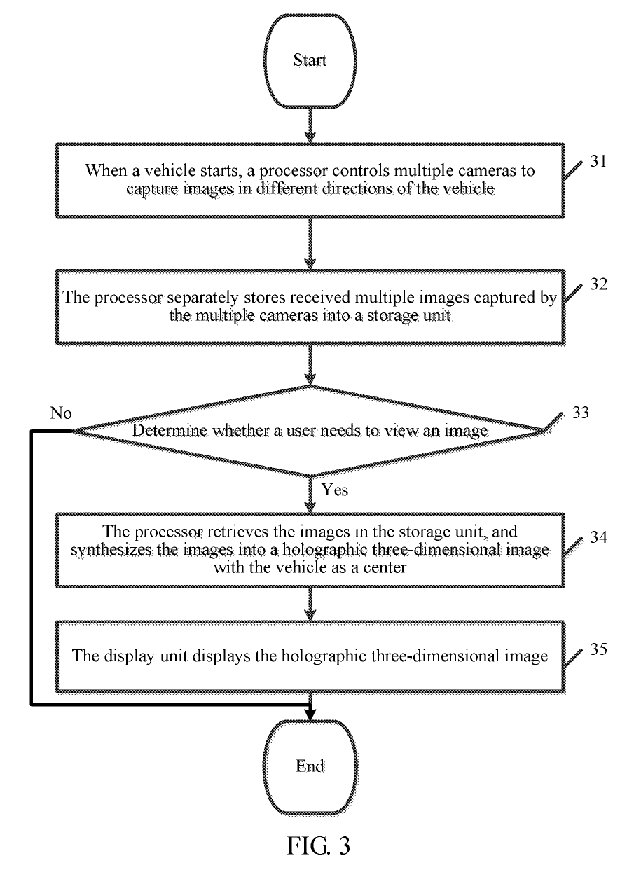

Referring to FIG. 3, which is a flowchart of an exemplary embodiment of a holographic drive recording method provided in present disclosure. According to different requirements, execution sequences of steps in the flowchart shown in FIG. 3 may be changed, and some steps may be omitted.

Step S31: When a vehicle 2 starts, a processor 20 controls a plurality of cameras to capture images in different directions of the vehicle 2 simultaneously.

Step S32: The processor 20 stores a plurality of images captured by the plurality of cameras into a memory 30.

Step S33: Determine whether a user needs to view an image. If the user needs to view the image, Step S34 is executed; or if the user does not need to view the image, the process is ended. In some embodiments, when the user does not need to view the image, the process may further return to Step S31, and the plurality of cameras continue to capture images.

Step S34: the processor 20 retrieves the images in the memory 30, and synthesizes the images into a holographic three-dimensional image with the vehicle 2 as a center.

In this embodiment, the processor 20 may further include digital image processing software, where the software can synthesize a plurality of two-dimensional images into the holographic three-dimensional image. And the first image, the second image, the third image, the fourth image, and the fifth image are corrected first to ensure that the five images have no distortions. In this embodiment, a perspective transformation algorithm or a control-point transformation algorithm may be used to perform correction. Then a corrected five images are tailored, to reserve an image of a visual area that uses a body of the vehicle 2 as a center. Equalization processing further needs to be performed on an overlapping area between every two images in the first to fourth images, so that the image of each overlapping area can have a smooth transition, to prevent the user from feeling a stitching effect when watching the image. Finally, images after the equalization processing can be synthesized into the holographic three-dimensional image.

Step S35: the display unit 40 displays the holographic three-dimensional image.

In addition, the processor 20 of the present disclosure may further turn off the plurality of cameras to save energy when the vehicle 2 is in a flameout state. When the vehicle 2 starts again, the processor 20 turns on the plurality of cameras to capture images in real time.

Exemplary embodiments of the present disclosure are described above, which are not used to limit the present disclosure. Any modification, equivalent replacement, and improvement made without departing from the spirit and principle of the present disclosure shall fall within the protection scope of the present disclosure.

What is claimed is:

1. A holographic drive recording apparatus, used to record images during a driving process of a vehicle, the apparatus comprising:
a plurality of cameras,
a processor connected to the plurality of cameras, and
a memory connected to the processor,
wherein the plurality of cameras is configured to simultaneously capture images in different directions of the vehicle, the memory is configured to store the plurality of images, and the processor is configured to retrieve the plurality of images and synthesize the plurality of images into a holographic three-dimensional image with the vehicle as a center when a user needs to watch an image.

2. The apparatus according to claim 1, wherein, the apparatus further comprises a display unit configured to display the holographic three-dimensional image.

3. The apparatus according to claim 2, wherein, the plurality of cameras comprise at least cameras separately installed in a front of, on a left of, on a right of, and in a rear of the vehicle, and a camera installed near a wheel of the vehicle.

4. The apparatus according to claim 3, wherein, the plurality of cameras are wide angle cameras.

5. The apparatus according to claim 4, wherein, the processor is a digital signal processing unit.

6. A holographic drive recording method, applied to a driving process of a vehicle, wherein the method comprises:
At electronic device;
simultaneously capturing a plurality of images in different directions of the vehicle;
storing the plurality of images; and
retrieving the plurality of images and synthesizing the plurality of images into a holographic three-dimensional image with the vehicle as a center when a user needs to watch an image.

7. The method according to claim 6, wherein the method further comprises:
displaying the holographic three-dimensional image.

8. The method according to claim 7, wherein the plurality of images comprises at least images in a front of, on a left of, on a right of, and in a rear of the vehicle, and an image near a wheel of the vehicle.

9. The method according to claim 8, wherein the plurality of images is shot by using wide angle cameras.

10. The method according to claim 9, wherein the retrieving the plurality of images and synthesizing the plurality of images into the holographic three-dimensional image with the vehicle as the center specifically comprises:
retrieving the plurality of images and synthesizing the plurality of images into the holographic three-dimensional image with the vehicle as the center by using a digital signal processor.

11. A non-transitory computed readable storage medium storing executable instructions, wherein when the executable instructions are executed by at least one processor causes the at least one processor to:
simultaneously capture a plurality of images in different directions of the vehicle;
store the plurality of images; and
retrieve the plurality of images and synthesize the plurality of images into a holographic three-dimensional image with the vehicle as a center when a user needs to watch an image.
